(19) United States
(12) Patent Application Publication
(10) Pub. No.: US 2008/0022974 A1
(43) Pub. Date: Jan. 31, 2008

(54) Multi-stage relief valve having different opening pressures

(75) Inventors: Alan R. Stockner, Metamora, IL (US); Mandi Rae Ferleyko, Metamora, IL (US); Benjamin Ray Tower, Varna, IL (US); Bryan D. Moore, Washington, IL (US); Koti Ratnam Padarthy, Peoria, IL (US); Fergal Michael O'Shea, Washington, IL (US); Todd Alan Johnson, Metamora, IL (US); James Dl, Peoria, IL (US)

Correspondence Address: CATERPILLAR/FINNEGAN, HENDERSON, L.L.P., 901 New York Avenue, NW, WASHINGTON, DC, 20001-4413, US

(73) Assignee: Caterpillar Inc.

(21) Appl. No.: 11/494,581

(22) Filed: Jul. 28, 2006

(51) Int. Cl. F02M 69/54; F16K 17/20

(52) U.S. Cl. 123/457; 137/469

(57) ABSTRACT

A pressure relief valve is provided for a common rail fuel system. The pressure relief valve has a housing with an inlet, an outlet, and a central bore fluidly connecting the inlet and the outlet. The pressure relief valve also has a single valve seat and a first valve element movable to selectively block a flow of fluid through the single valve seat. The pressure relief valve further has a second valve element disposed within the central bore of the housing and movable to selectively block a flow of fluid through the central bore.

### TECHNICAL FIELD

The present disclosure is directed to a relief valve and, more particularly, to a multi-stage relief valve having different opening pressures.

### BACKGROUND

Many different fuel systems are utilized to introduce fuel into the combustion chambers of an engine. One type of fuel system is known as the common rail system. A typical common rail system utilizes one or more pumping mechanisms to pressurize fuel and direct the pressurized fuel to a common manifold also known as the rail. Individual injectors draw pressurized fuel from the common rail and inject one or more shots of fuel per cycle into the combustion chambers. In order to optimize operation of the engine, fuel within the rail is maintained within a desired pressure range through precise control of the pumping mechanisms. However, there may be situations in which this precise control is interrupted and pressure fluctuations or spikes occur. Without intervention, these pressure spikes could damage fuel system components.

One way to protect the fuel system from undesired pressure spikes includes draining fuel from the common rail as the pressure of the fuel therein exceeds a predetermined maximum threshold value. An example of this protection method is disclosed in U.S. Pat. No. 6,244,253 (the '253 patent) to Hacberer et al., issued on Jun. 12, 2001. The '253 patent describes using a pressure control valve in conjunction with a fuel injection system. The pressure control valve includes a first piston with an integral sealing sphere. The integral sealing sphere is movable by fuel pressure against a spring bias in an axial direction between away from a conical seat toward a stop. When the sealing sphere is away from the conical seat, high pressure fuel from an associated manifold is communicated with a first chamber of the valve. The first piston has through-bores, which fluidly connect the first chamber with a conical interior of the first piston. The pressure control valve also includes a second piston disposed within the first piston and movable by the same spring bias in the axial direction to engage the conical interior thereof and thereby close the through-bores. When the second piston is moved away from the conical interior and through-bores of the first piston, high pressure fuel from the first chamber is communicated with a low pressure drain via through-bores in the second piston.

Initially, the first piston of the '253 patent is opened by a high pressure within a short time period. Following the opening of the first piston, the building pressure within the first chamber urges the second piston to move away from and unblock the through-bores of the first piston to drop the pressure of the fuel within the manifold. By adjusting the position of the second piston relative to the first piston, the pressure can be kept at a predetermined value less than the high pressure for use during a “limp-home” phase of operation.

Although the pressure control valve of the '253 patent may sufficiently protect other fuel system components by relieving the manifold of excessive pressures, it may be expensive. In particular, all of the valve seats included within the pressure control valve of the '253 patent are conical. For proper sealing, conical valve seats must be manufactured to tight tolerances and often require grinding and polishing processes. These tight tolerances and complicated manufacturing processes can significantly increase the cost of a system employing multiple conical seats. In addition, the multiple through bores within each of the separate pistons further increase the manufacturing costs and complexity of the pressure control valve.

The disclosed fuel system is directed to overcoming one or more of the problems set forth above.

### SUMMARY OF THE INVENTION

One aspect of the present disclosure is directed to a pressure relief valve. The pressure relief valve includes a housing with an inlet, an outlet, and a central bore fluidly connecting the inlet and the outlet. The pressure relief valve also includes a single valve seat and a first valve element movable to selectively block a flow of fluid through the single valve seat. The pressure relief valve further includes a second valve element disposed within the central bore of the housing and movable to selectively block a flow of fluid through the central bore.

Another aspect of the present disclosure is directed to a method of operating a fluid system. The method includes pressurizing fluid and directing the pressurized fluid to a common rail. The method also includes moving a first valve element away from a valve seat to pass fluid from the common rail to a second valve element, and moving a shoulder out of a central bore to pass fluid from the first valve element to a low pressure drain.

### BRIEF DESCRIPTION OF THE DRAWINGS

FIG. 1 is a schematic illustration of an exemplary disclosed fluid system;

FIG. 2 is a cross-sectional illustration of an exemplary disclosed pressure relief valve for use with the fluid system of FIG. 1;

FIG. 3A is a pictorial illustration of an exemplary disclosed valve element for use with the pressure relief valve of FIG. 2; and

FIG. 3B is a pictorial illustration of another exemplary disclosed valve element for use with the pressure relief valve of FIG. 2.

### DETAILED DESCRIPTION

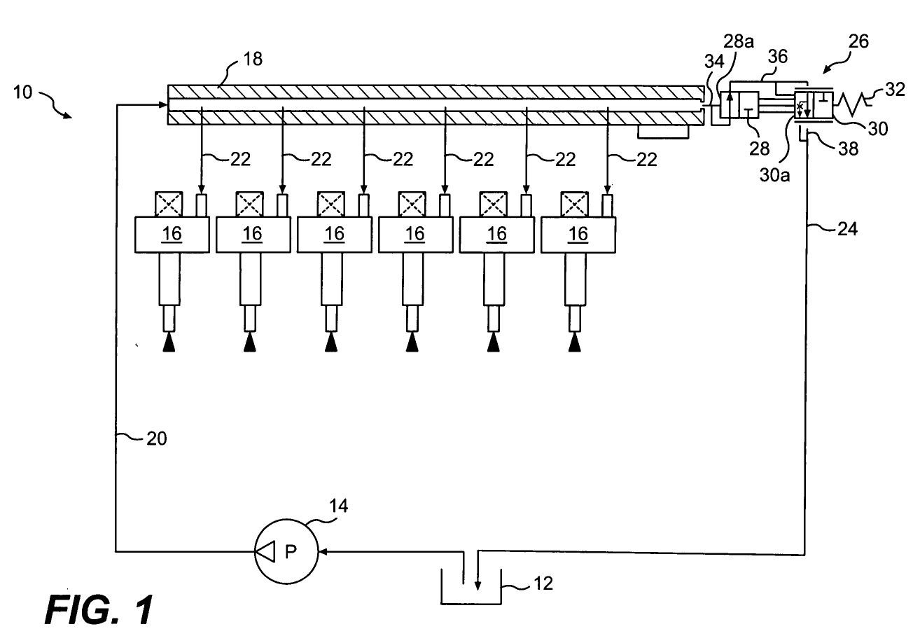

FIG. 1 illustrates an exemplary fluid system 10. In this example, fluid system 10 may embody a fuel injection system having a supply 12 of fluid and a pumping mechanism 14 that pressurizes and directs the fluid to a plurality of fuel injectors 16 by way of a common rail 18. The fluid may include a fuel, a dedicated hydraulic oil, engine oil, or any other fluid used by fuel injectors 16 for direct injection or for actuation of an injection event. It is contemplated that fluid system 10 may alternatively embody a non-fuel related hydraulic system such as, for example, a machine system configured to move a cylinder associated with a work implement, a transmission system, an engine lubrication system, or any other type of hydraulic system known in the art.

Supply 12 may constitute a reservoir configured to hold a supply of fluid. One or more hydraulic systems associated with the power source may draw fluid from and return fluid to supply 12. It is contemplated that fluid system 10 may be connected to multiple separate fluid supplies, if desired.

Pumping mechanism 14 may produce a flow of pressurized fluid and may include any suitable source of pressure such as, for example, a variable displacement pump, a fixed displacement pump, a variable flow pump, or any other source known in the art. Pumping mechanism 14 may be dedicated to supplying pressurized fluid to only fluid system 10 or may, alternatively, supply pressurized fluid to multiple separate hydraulic systems.

Each of fuel injectors 16 may be associated with a different combustion chamber (not shown) of the power source. Fuel injectors 16 may be operable to inject an amount of pressurized fuel into the combustion chambers at predetermined timings, fuel pressures, and fuel flow rates. Fuel injectors 16 may be mechanically, electrically, pneumatically, or hydraulically operated.

Common rail 18 may embody a hollow tubular member that distributes fluid from pumping mechanism 14 and returns fluid to supply 12. In particular, common rail 18 may connect pumping mechanism 14 to fuel injectors 16 by way of a main supply line 20 and a plurality of branch lines 22. Common rail 18 may also be connected to supply 12 by way of a main return line 24. In this manner, pumping mechanism 14 may draw fluid from supply 12, pressurize the fluid, direct the pressurized fluid to each fuel injector 16, and return excess fluid to supply 12.

As also illustrated in FIG. 1, fluid system 10 may include a pressure relief valve 26 located to relieve common rail 18 of excessive pressures. Pressure relief valve 26 may be disposed within return line 24, between common rail 18 and supply 12. As a pressure of the fluid within common rail 18 exceeds a predetermined maximum threshold value, pressure relief valve 26 may open to fluidly connect common rail 18 with supply 12, thereby allowing fluid to drain from common rail 18 and reduce the pressure therein.

Pressure relief valve 26 may include an assembly of components that cooperate to relieve the pressure within common rail 18. Specifically, pressure relief valve 26 may include a first valve element 28, a second valve element 30, a single return spring 32, and a shim element 33. First valve element 28 may be mechanically connected to move with second valve element 30. Return spring 32 may bias both first and second valve elements 28, 30 toward flow blocking positions. Shim element 33 may be used to cost effectively set the bias of return spring 32.

First valve element 28 may be a two position element movable in response to a pressure within common rail 18. In particular, an inlet 34 of pressure relief valve 26 may communicate pressurized fluid from common rail 18 with a hydraulic surface 28a of first valve element 28. Because first valve element 28 may be mechanically connected through second valve element 30 with return spring 32, first valve element 28 may remain in a first of the two positions until a force generated by the common rail pressure acting on hydraulic surface 28a exceeds the spring's biasing force. When the force generated by the pressure of common rail 18 exceeds the biasing force of return spring 32, first valve element 28 may move from the first position at which fluid from common rail 18 is blocked from the second valve element 30, to a second position at which the fluid flows from first valve element 28, through a central bore 36 of pressure relief valve 26, to second valve element 30. In one example, the pressure required to move first valve element 28 away from the first position may be in the range of about 180-240 MPa. To minimize hunting of first valve element 28 between the first and second positions, a restrictive orifice 35 may be located between inlet 34 and central bore 36.

Second valve element 30 may be a proportional valve element movable in response to a pressure of the fluid within central bore 36. In particular, fluid within central bore 36 may act against a hydraulic surface 30a of second valve element 30. Because of the bias of return spring 32 acting directly on second valve element 30, second valve element 30 may remain in a flow-blocking position until a force generated by the pressure of the fluid on hydraulic surface 30a exceeds the biasing force of return spring 32. When the force generated by the pressure of the fluid within central bore 36 exceeds the biasing force of return spring 32, second valve element 30 may move from the flow-blocking position at which fluid from common rail 18 is blocked from supply 12, toward a second position at which the fluid from common rail 18 flows through an outlet 38 of pressure relief valve 26 to supply 12. Second valve element 30 may be movable to any position between the first and second positions in response to the pressure of the fluid within central bore 36 to vary the flow rate of fluid passed to supply 12. In one example, the pressure required to move second valve element 30 away from the first position may be about 6-8 times less than the pressure required to move first valve element 28 away from its first position (e.g., about 35 MPa).

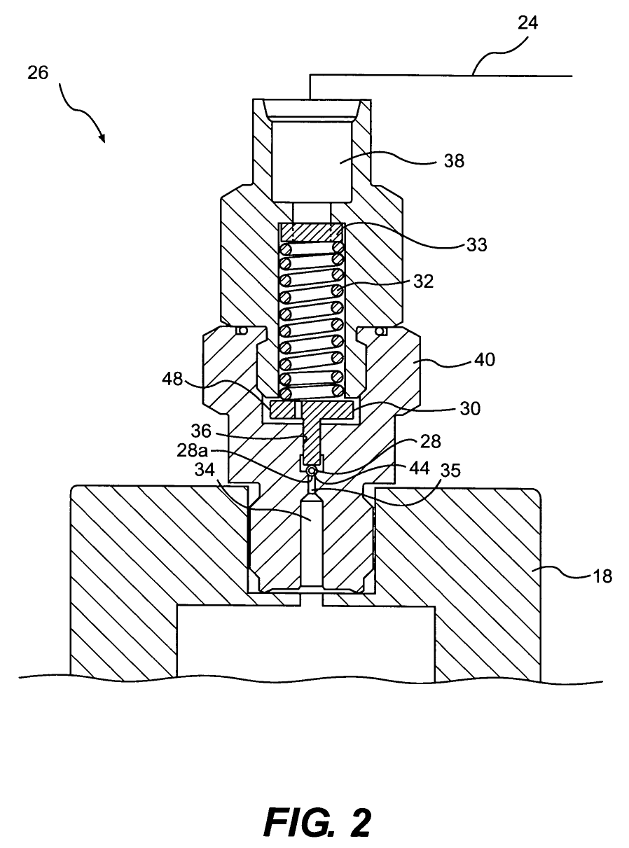

FIG. 2 illustrates one exemplary physical embodiment of pressure relief valve 26. In this embodiment, pressure relief valve 26 may include a housing 40 having central bore 36 connecting inlet 34 and outlet 38, and a conical valve seat 44 disposed between inlet 34 and central bore 36. Conical valve seat 44 may receive first valve element 28, while central bore 36 may receive second valve element 30.

In the embodiment of FIG. 2, first and second valve elements 28 and 30 may be separate components maintained in mechanical engagement during operation by return spring 32. Specifically, first valve element 28 may be either a spherical ball or conical-type element configured for engagement and sealing with conical valve seat 44. In contrast, second valve element 30 may be a spool-type valve element in contact with first valve element 28. Return spring 32 may urge second valve element 30 into central bore 36 and into engagement with first valve element 28, thereby urging first valve element 28 toward engagement with conical valve seat 44.

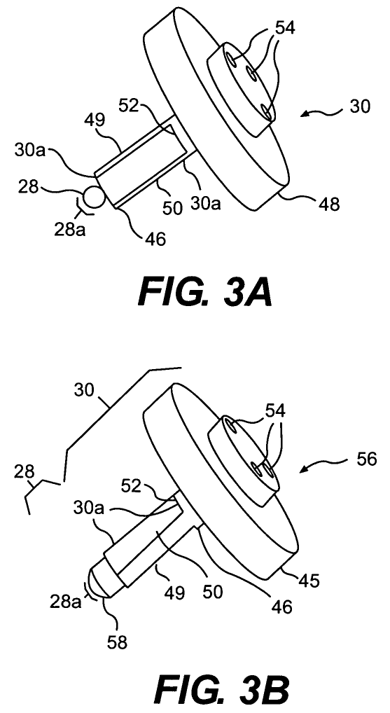

As illustrated in FIG. 3A, second valve element 30 may include a piston member 46 and a flange member 48. Piston member 46 may include a cylindrical outer surface 49 received within central bore 36 such that substantially no fluid leaks therebetween. One or more recesses 50 may be located within outer surface 49 of piston member 46 and oriented to form an interrupted shoulder 52. When shoulder 52 is within central bore 36, the flow of fluid from first valve element 28 to outlet 38 may be prevented. When shoulder 52 is moved up away from first valve element 28 and out of central bore 36, fluid may flow through the space within central bore 36 created by recesses 50. The distance between shoulder 52 and a rim of central bore 36 may correspond with a flow area and affect the flow rate of fluid through central bore 36. Because the area of hydraulic surface 30a is greater than the area of hydraulic surface 28a, the pressure required to move second valve element 30 may be less than the pressure to move first valve element 28.

As piston member 46 is moved upward out of central bore 36, fluid may flow in several different paths relative to flange member 48. In particular, flange member 48 may include one or more through holes 54. As shoulder 52 emerges from central bore 36, fluid from recesses 50 may simultaneously pass through holes 54 and around an outer periphery of flange member 48. In this manner, through holes 54 may reduce drag and the likelihood of bounce associated with the movement of piston member 46.

FIG. 3B illustrates an alternative valve element 56 for use with pressure relief valve 26. In this embodiment, first and second valve elements 28 and 30 may be combined into a single integral component. Specifically, valve element 56 may include piston member 46 having recesses 50 and interrupted shoulder 52, flange member 48, and a spherical sealing surface 58. Spherical sealing surface 58 may be configured to engage and seal against conical seat 44 (referring to FIG. 2). By combining the two separate elements (e.g., first and second valve elements 28 and 30) into a single component (e.g., valve element 56), manufacturing cost may be reduced and reliability and durability increased.

### INDUSTRIAL APPLICABILITY

The disclosed fluid system has wide use in a variety of applications including, for example, fuel systems, lubrication systems, work implement actuation systems, transmission systems, and other hydraulic systems, where protection from excessive pressures is desired. The disclosed fluid system may provide the desired protection by implementing a multi-stage pressure relief valve. When the pressure of the fluid within the system exceeds a maximum threshold value, the multi-stage pressure relief valve may drain fluid from the system, thereby lowering the pressure of the fluid within the system. The pressure of the fluid within the system may be lowered just enough to protect the system without creating instability or completely disabling the system. The operation of fluid system 10 will now be explained.

During operation of fluid system 10, pumping mechanism 14 may draw fluid from supply 12, pressurize the fluid, and direct the pressurized fluid to common rail 18. Pressure relief valve 26 may be in communication with the fluid of common rail 18 via inlet 34, and in fluid communication with supply 12 via outlet 38. As the pressure of the fluid within common rail 18 acting on hydraulic surface 28a exceeds the bias of return spring 32, first valve element 28 may move to the second or flow passing position, at which the fluid from common rail 18 is communicated with central bore 36 and hydraulic surface 30a of piston member 46. As the pressure of the fluid within central bore 36 acting on hydraulic surface 30a exceeds the bias of return spring 32, piston member 46 may be moved out of central bore 36 until interrupted shoulder 52 emerges an amount from central bore 36 and fluid passes through recesses 50 to outlet 38. As the fluid drains through outlet 38 back to supply 12, the pressure of the fluid within common rail 18 may reduce.

The amount that interrupted shoulder 52 extends above the rim of central bore 36 may correspond to a pressure of the fluid within common rail 18. That is, although first valve element 28 may be a substantially two-position element, second valve element 30 may be a proportional valve element movable between its first and second positions in response to the pressure within common rail 18. Once first valve element 28 has opened, the resulting pressure within common rail 18 may no longer be controlled by first valve element 28. Instead, the movement of second valve element 30 may regulate the pressure of the fluid within common rail 18 and ensure that it remains low enough for component protection, yet high enough for continued injector operation. For example, once second valve element 30 has opened, an increase in pressure within common rail 18 may push interrupted shoulder 52 further out of central bore 36, thereby increasing a flow area for fluid draining from common rail 18. The increased flow area may result in a greater flow rate of fluid from common rail 18 to supply 12 and, subsequently, a lower pressure within common rail 18. Conversely, as the pressure within common rail 18 decreases, interrupted shoulder 52 may retract back into central bore 36 and reduce the flow area. The reduced flow area may result in a lower flow rate of fluid from common rail 18 and, subsequently, a higher pressure within common rail 18. Once first valve element 28 opens to pass fluid, it may remain open until interrupted shoulder 52 of second valve element 30 is nearly or completely retracted into central bore 36.

The disclosed pressure relief valve may be a low cost alternative to controlling pressure within a common rail. Specifically, because pressure relief valve 26 utilizes only a single conical valve seat, the cost of fluid system 10 may be lower than other systems employing multiple conical valve seats. In addition, because first valve element 28 does not include any internal fluid passageways, the manufacturing cost of pressure relief valve 26 may be small. Further, because first and second valve elements 28, 30 may be combined into a single integral component, the component cost of pressure relief valve 26 may be reduced even more.

It will be apparent to those skilled in the art that various modifications and variations can be made in the fluid system of the present disclosure without departing from the scope of the disclosure. Other embodiments will be apparent to those skilled in the art from consideration of the specification and practice of the fluid system disclosed herein. It is intended that the specification and examples be considered as exemplary only, with a true scope being indicated by the following claims and their equivalents.

What is claimed is:

1. A pressure relief valve, comprising:
a housing including:
an inlet;
an outlet; and
central bore fluidly connecting the inlet and the outlet
a single valve seat;
a first valve element movable to selectively block a flow of fluid through the single valve seat; and
a second valve element disposed within the central bore of the housing and movable to selectively block a flow of fluid through the central bore.

2. The pressure relief valve of claim 1, wherein the single valve seat is a conical valve seat disposed between the inlet and the central bore.

3. The pressure relief valve of claim 1, wherein the first valve element is spherical.

4. The pressure relief valve of claim 1, wherein the second valve element is a spool valve element.

5. The pressure relief valve of claim 1, further including a single spring configured to bias the first valve element and the second valve element toward flow-blocking positions.

6. The pressure relief valve of claim 5, wherein a pressure required to move the first valve element is greater than a pressure required to move the second valve element.

7. The pressure relief valve of claim 1, wherein the first and second valve elements are included within a single integral component.

8. The pressure relief valve of claim 1, wherein the inlet includes a restrictive orifice.

9. The pressure relief valve of claim 1, wherein the second valve element includes a piston member having:
a substantially cylindrical outer surface; and
at least one recess located within the outer surface to form an interrupted shoulder,
wherein, when the interrupted shoulder is within the central bore, the flow of fluid through the central bore is blocked.

10. The pressure relief valve of claim 9, wherein the second valve element further includes a flange member protruding substantially perpendicular to the cylindrical outer surface and having a through-hole radially-removed from a central axis of the cylindrical outer surface.

11. The pressure relief valve of claim 10, wherein fluid flowing through the central bore may flow both through the through-hole and around an outer periphery of the flange member.

12. A method of operating a fluid system, comprising:
pressurizing fluid;
directing the pressurized fluid to a common rail;
moving a first valve element away from a valve seat to pass fluid from the common rail to a second valve element; and
moving a shoulder out of a central bore to pass fluid from the first valve element to a low pressure drain.

13. The method of claim 12, further including:
biasing the first valve element toward the valve seat; and
biasing the shoulder into the central bore,
wherein the biasing force of the first valve element is substantially the same as the biasing force of the second element.

14. The method of claim 13, wherein a valve opening pressure of the first valve is greater than a valve opening pressure of the second valve.

15. The method of claim 12, wherein passing fluid from the first valve element to the low pressure drain includes passing fluid through and around the second valve element.

16. A fuel system, comprising:
a supply of fuel;
a source configured to pressurize the fuel;
a common rail in communication with the source; and
a pressure relief valve disposed between the common rail and the supply, the pressure relief valve including:
a housing having:
an inlet fluidly connected to the common rail;
an outlet fluidly connected to the supply; and
central bore fluidly connecting the inlet and the outlet;
a conical valve seat disposed between the inlet and the outlet;
a first valve element movable to selectively block a flow of fluid through the conical valve seat;
a spool valve element disposed within the central bore of the housing and movable to selectively block a flow of fluid through the central bore; and
a single spring configured to bias the first valve element and the spool valve element toward flow-blocking positions.

17. The fuel system of claim 16, wherein the first valve element is spherical.

18. The fuel system of claim 16, wherein a pressure required to move the first valve element is greater than a pressure required to move the second valve element.

19. The fuel system of claim 16, wherein the first and second valve elements are included within a single integral component.

20. The fuel system of claim 16, wherein the second valve element includes a piston member having:
a substantially cylindrical outer surface; and
at least one recess located within the outer surface to form an interrupted shoulder,
wherein, when the interrupted shoulder is within the central bore, the flow of fluid through the central bore is blocked.
